(19) United States
(12) Patent Application Publication
(10) Pub. No.: US 2013/0153509 A1
(43) Pub. Date: Jun. 20, 2013

(54) WASTEWATER TREATMENT COMPRISING ELECTRODISSOLUTION, FLOCCULATION AND OXIDATION

(71) Applicants: Fiderman Machuca Martinez, Cali (CO); Nilson de Jesus Marriaga Cabrales, Cali (CO); Charles Eduardo Cardona Palomino, Cali (CO)

(72) Inventors: Fiderman Machuca Martinez, Cali (CO); Nilson de Jesus Marriaga Cabrales, Cali (CO); Charles Eduardo Cardona Palomino, Cali (CO)

(21) Appl. No.: 13/703,796

(22) PCT Filed: Jun. 15, 2011
(86) PCT No.: PCT/IB11/52609

§ 371 Date: Feb. 27, 2013

(30) Foreign Application Priority Data
Jun. 16, 2010 (CO) 10072421

(51) Int. Cl. C02F 9/00

(52) U.S. Cl. CPC C02F 9/00
USPC 210/712; 210/721

(57) ABSTRACT

The present invention claims a process to reduce COD, TOC, and total solids from a contaminated liquid medium, which comprises of the following stages: feed an electrolytic cell provided with electrodes with the contaminated liquid medium; apply a constant direct current through said electrodes; flocculate the solids present in said contaminated liquid medium by adding coadjuvant agents, remove sludge and supernatant obtained; and oxidize the supernatant through oxidizing agents.

### FIELD OF THE INVENTION

The present invention is related to a novel process for the reduction of chemical oxygen demand (COD), total organic carbon (TOC), and the content of total solids present in industrial waste waters or wastewaters among which are included, but not limited to: a) leachate from landfills of urban solid wastes; b) vinasse produced in ethanol distilleries: c) vinasse produced in yeast producing plants; d) production waters from petroleum wells; e) waters contaminated with flexographic inks or textile dyes; and f) acid drainage from coal mines. The treatment comprises coupling three processes: iron (or aluminum) electrodissolution, chemical flocculation, and advanced oxidation.

The process proposed consumes little electrical energy en la metal electrodissolution (less than 1.5 kWh/m³) due to the management of low current densities, which places it at advantage against conventional electrocoagulation. Likewise, it avails of the fact that coagulant dosing (iron or aluminum) through this route results less costly than dosing with inorganic salts.

By conducting flocculation during a separate stage, the treatment permits controlling the formation of floccules in practical manner by adding coadjuvant agents and with appropriate pH control.

Unlike known oxidation treatments (ozone, Fenton, electro-oxidation, etc.), the treatment proposed does not seek to degrade the organic matter contained in the wastewater, but rather applies oxidation as final treatment to eliminate the organic and inorganic waste burden; consequently, the consumption of oxidizing agents is reduced to a minimum.

Because it is a physical-chemical process, variations in the characteristics of the effluent fed do not sensibly affect the efficiency of the technique as is the case with biological treatments.

### BACKGROUND OF THE INVENTION

In technical literature, numerous procedures are known for the use of solid wastes from dumps and urban waste landfills, as agricultural fertilizers, the following are among the most important:

1. Heating energy use by incineration of wastes

### 2. Recycling

3. Controlled treatments that comprise covering wastes with dry substances, to avoid treatment of contaminated waters produced by the effects of rain.

These treatments result troublesome when they are conducted in warm and humid climatic zones due to the generation of waste liquids produced by the slow passage of water through the permeable material present in sanitary landfills. These liquids are denominated “leachate” and are produced on the groundwater of landfills or in courses of surface waters. Said leachate is toxic due to the degradation of the organic material deposited on the landfills and the increase of their corrosive character by the effect of the dissolution of atmospheric CO₂ in water.

Numerous limitations exist to treat leachate derived from the difficulty to guide them to a landfill in controlled manner, given that anaerobic fermentation processes generate malodorous gases and effluents with repugnant aspect.

Habitually, partial filtration and purification processes are used with coating materials, drainage, and waterproofing and collection for their treatment outside the landfill or recirculation without applying any treatment. However, these treatments do not reduce the contaminating capacity of the leachate and do not solve the problem of the contamination they generate through a practical and economic process.

In the state of the technique, numerous procedures are known for use, as agricultural fertilizer, of solid organic wastes, procedures that only treat the solid fraction of the wastes, for example, to produce biogas—essentially in the form of methane. Such is the case of patent publications U.S. Pat. No. 4,026,355 and ES2023591, which mention methods to produce methane gas from urban solid wastes deposited in landfills.

Other patent publications like ES86000942 and WO9937587 mention treatments applied to the liquid fraction of wastes from urban solid wastes, generated in leachate form, which only take care of the storage, purification, and neutralization problem of the contaminating liquids.

Patent document ES2261048 mentions the treatment of leachate from urban solid wastes through fermentation techniques with microorganisms like bacteria and yeasts, specifically with Methanebacterium, Methanebrevibacter, Methanespirilum, and Methanesarcina.

Generation of leachate is an inevitable consequence of wastewaters discharged into a sump, and it is generated as a result of the solubilization of the masses present in sanitary landfills (this is because the water presents a high retention time inside the landfill within a highly anaerobic environment), which is why contamination of the effluent is produced with organic substances and heavy metals. This situation generates highly toxic leachate that cannot be re-circulated. To treat the leachate, publication ES2218993 proposes a system of damp soils that includes stages like precipitation of impurities and separation of sludge, until the water is finally brought to an adsorption and retention stage through the system of compressed damp soils and from there it is transferred to a natural receptor like a lake or a swamp.

In the process indicated, the chemical precipitation is carried out in a facility that comprises a de-aerating device and a dispenser of the chemical substances, as well as a pH and conductivity controller. The device also includes a precipitation chamber, a filter with reagent media and a sludge receptacle. Upon accomplishing the separation of sludge, these are treated with plaster or absorbent materials to achieve binding the heavy metals.

In the process mentioned, the retention stage is carried out to reduce the amount of nitrogen and metallic wastes; a system of damp soils is used for this, composed of a series of interconnected dams in which there is absorbent material or organic plant material with sand filler. The damp soils are adapted in this system to be subjected to cyclical loads to permit reaching anaerobic and aerobic periods lasting approximately one week. The system proposed in publication ES2218993 effectively combines natural systems with chemical procedures, but to carry it out a pretreatment stage is required, which produces the elimination of heavy metals to avoid the retention of highly toxic impurities on damp soils.

Thus, the general panorama related to treating leachate from sanitary landfills and municipal dumps clearly evidences that no procedure exists based on the combination and application of electrodissolution, flocculation, and oxidation techniques. And given that leachate from sanitary landfills can reach harmful chemical oxygen demands and biological oxygen demands for the aquatic flora and fauna, it is indispensable to design and develop a procedure that permits reducing the content of total solids present in the leachate.

Also, the wine produced during fermentation in ethanol distilleries has an alcohol content between 8 and 10% v/v, with water being the remaining part, which additionally contains different minerals (sulphates, phosphates, calcium carbonates, potassium, magnesium, and iron) and a high content of organic matter (BOD up to 40,000 mg/l and COD up to 120,000 mg/l). According to the aforementioned, and for the Colombian case, for every liter of ethanol between 10 and 12 liters of raw vinasse can be produced.

Upon extracting ethanol from this mixture an effluent is obtained, known as vinasse, with the previously mentioned constituents (with a solids content above 6% p/p). Because of its composition, it would be detrimental to discharge raw vinasse directly onto water sources: the high organic load would consume their oxygen, depleting flora and fauna; additionally, the high mineral content would cause eutrophication of waters.

In many distilleries, much of the raw vinasse is re-circulated to the fermentation stage, without appearance of inhibitory effects caused by the content of solids or by volatile acidity (content of acetic, lactic, propionic, and butyric acids) and the rest is concentrated through evaporation until obtaining concentrated vinasse (25 to 35% p/p). During this stage what is sought is to reach the minimum concentration of solids required to continue with a composting stage, which aims to use the organic matter and minerals present to produce fertilizers. The concentration of solids is an operation with high energy demand that is developed in the alcohol production plant and which, as a result, affects the process in economic terms.

It is important to indicate that vinasse contains a high proportion of potassium salts, calcium and magnesium, which is why during the concentration process, the incrustation phenomenon (deposits of insoluble salts) frequently occurs in heat transfer equipment, especially in evaporator tubes due to the deposition of salt crystals like K₂SO₄ that causes heating of the vinasse. Said situation forces recurrent interruptions and increased costs of the process, besides restrictions in maximum solid concentration levels during the same process (maximum 55% p/p). And for effluents from sanitary landfills, the concentration can derive into a higher contaminating effect, as a result of the production of nauseating gases.

In the state of the technique some anaerobic treatments are published, which seem to be the most attractive to reduce the organic load of the vinasse, given that with these energy is recovered from the biogas. However, it has been noted that these treatments do not degrade melanoidin, a substance that causes the Brown color of vinasse, which constitutes a refractory contaminant because it comes from industrial wastes and which because of its characteristics tends to be resistant to conventional treatments, and because of its characteristics the effluent cannot be reused to irrigate crops, nor can it be discharged into bodies of water.

Melanoidins are polymers of high molecular weight formed from the reaction sugars and amino acids under alkaline conditions (Maillard reaction), or in more general manner, through the reaction between amino and carboxyl groups of organic substances. These substances have antioxidant properties and are frequently toxic to microorganisms used in biological treatments of effluents, which has interfered in the development of conventional methods to treat distillery vinasse and has provoked the search for alternatives to accomplish discoloration and elimination of the high organic load of these types of effluents.

This situation has motivated researchers to combine the anaerobic treatment with prior advanced oxidation treatments or with subsequent aerobic treatments recurring to the capacity fungus and bacteria to degrade them, but high loads of additional nutrients are required. Another process used to eliminate melanoidins corresponds to clarification of vinasse, by diluting the product and via high-efficiency centrifuge (ES2167437).

Some waste elimination processes exist that are carried out through chromatographic separation and ion exchange; however, these require no insoluble solids in the vinasse. Thereby, vinasse clarification has always resulted in a costly or difficult process and, in the best of cases; vinasse pretreated with known methods turns out unstable and precipitates after the treatment.

Other methods, like chemical coagulation with inorganic salts such as FeSO₄, FeCl₃, Al₂SO₄, PAC have proven effective when applied to reduce the color of the vinasse subjected to prior biological treatments and which present high melanoidin content. However, this treatment presents certain limitations derived from high consumption in chemical inputs.

Physical-chemical treatments also exist that recur to the use of absorbent and coagulant agents, as well as processes like electrochemical oxidation or even the use of membranes for filtration, but no method exists that can conduct a complete treatment and which additionally guarantees the use of the vinasse.

For the electrodissolution technique and subsequent flocculation to treat wastewaters from distilleries, the concentration of contaminants from effluents is reduced by applying an electric current that generates metallic cations that promote destabilization of suspended, emulsified, or dissolved contaminating particles in the aqueous medium. Through the effect of a series of chemical reactions, the contaminants precipitate or float, facilitating reduction of their concentration via secondary separation methods, like electroflotation (Holt, et al., 2005).

Although evidence is available related to COD reduction of up to 99.9% by using an electroflotation system to treat waters from restaurants (Xueming, et al., 2000), electrocoagulation of waters from the textile industry with reduced turbidity and COD demand of up to 98 and 75%, respectively (Mehmet K., Orhan T., Mahmut B., 2003), reduction of boron content from wastewaters by using electrocoagulation with CaCl₂ with efficiency of up to 97% (Yilmaz, et al., 2005), reduction of nitrate content via electrocoagulation and electro-reduction with efficiency up to 68% (Koparal S., Ogutveren B., 2002), and reduction of arsenic content from underground waters contaminated with heavy metals with efficiency up to 99% (Parga, et al., 2005); conventional electrocoagulation has not been effectively applied to treat leachate from sanitary landfills and from contaminating effluents from ethanol distilleries to reduce melanoidin content without the need to recur to pretreatments.

Some conventional treatments of vinasse-type wastes have recurred to the application of electrochemical methods seeking to mitigate possible contaminating effects. Thus is how electrodialysis techniques have been used to reduce salt content by a level close to 80% and complete reduction of potassium content (<1 mg/dm³) (Janusz, et al., 1988), or techniques have been combined like electrodialysis with cation exchange membranes to diminish the concentration of salts by up to 98% (Decloux, et al., 2002), and electrocoagulation and treatment with activated carbon of Areca catechu nuts have even been coupled to accomplish a decrease of COD levels above 80% (Kannan, et al., 2006).

Other processes in the state of the technique show combined treatments of conventional coagulation-chemical flocculation followed by a catalytic electro-oxidation stage with electrodes of metallic oxides supported on titanium: Ti/RuPb(40%)Ox and Ti/PtPd(10%)Ox, on biologically pretreated vinasse, reaching COD reductions of 97% (Zayas, et al., 2007).

Electrocoagulation has also been used along with a support electrolyte with gradual addition of hydrogen peroxide, which provides a reduction by 90% of total organic carbon (TOC) in biologically pretreated vinasse (Yusuf Y. et al, 2007).

Other cases have recurred to electrochemical techniques combined with treatment through ionic exchange membranes to reduce the deposition of salts on the exchanger tubes during the concentration of vinasse, presenting salt demineralization and concentration percentages between 98 and 80%, respectively (Decloux M. et al., 2002; Milewski J. et al., 1988). However, this process is not as convenient inasmuch as it does not recover the salts present in the effluent, given that once vinasse demineralization takes place, substances are eliminated with the application technique in the manufacture of agricultural sub-products, such is the case of the potassium salts in the form of titrate, nitrate, or phosphate and in other cases, as in the use of vinasse as animal food, the potassium level needs to diminish below 2 g/100 g of dry matter, without eliminating it completely from the liquid fraction.

Other methods related to la electrochemical decontamination de effluents are found in patent literature, as in the case of publication U.S. Pat. No. 5,538,636 that shows a process for purification and treatment of wastes, contaminated waters and wastewaters that contain industrial wastes. Nevertheless, the decontamination process mentioned presents high consumption of oxidizing agent and comprises the following stages:
a) Separate the purified water from the sludge in a container zone that permit its circulation;
b) Feed said waters containing iron III within a mixer; and
c) Recover the purified water

Patent EP0861810 refers to a process to treat liquid wastes from photo developing processes, which necessarily require a first stage of dilution and oxidation with oxygen and ozone to then precipitate the solids. Nevertheless, the high cost of generating ozone becomes one of its limitations.

Precipitation of solids is carried out by adding alkaline substances like soda (NaOH) or sodium carbonate (Na₂CO₃) and if necessary a suspension or slaked slime slurry (Ca(OH)₂) is incorporated into water, as coadjuvant substances of the process. Likewise, the process requires a prior treatment stage with ozone suction jets, to make sure the wastes are free of thiosulfate forms up to 95%. The electrolytic cell used en this process is of steel grids on the cathode and diamond-coated silicon disks in the anode.

Document U.S. Pat. No. 5,531,865 reveals a method to remove contaminants from wastewaters by using a purification device that includes conductive means y un electrolytic oxidation vessel, provided with a chamber containing in its interior and exterior an installation composed of a duo of conductive means, where the vessel has at least an elongated cathode electrode and a number of sacrificial anodes aligned in parallel with the cathode electrodes from the chamber, which present the following steps to treat wastewaters:
a) Guide an effluent of wastewaters into the conductive medium and through the electrolytic chamber containing the oxidation vessel, in parallel direction to the anode and cathode electrodes, so that the flow of wastewaters couples to the zone of cathode and anode electrodes;
b) Apply voltage through the sacrifice cathode electrode and the anode electrode to create a continuous current, with an approximate density of 5 to 50 mA/cm² to free ions from the anode electrode, permiting oxidation of insoluble contaminants present in electrolytic wastewater-oxidation;
c) Separate insoluble contaminants from substantially clean waters;
d) Disconnect the input and output of the installation of the conductive elements found in the vessel and tightly seal them to avoid corrosion of anode electrodes;
e) Thereafter, the conductive means are transferred to another vessel and the operation is repeated.

Said publication particularly refers to the method that permits separating sludge via coalescence or flocculation. During this stage, sludge is passed through rotary vacuum filters to obtain a paste that is combined with cementitious material to form a non-leachable solid. This stage includes adding a flocculating agent to the insoluble contaminants like lime (Ca(OH)₂) and injecting soda (NaOH) and calcium chloride CaCl₂ and even adding a polymer material to achieve flocculation of the insoluble contaminants.

Consequently, the electrochemical techniques to clarify vinasse have only been implemented as post-treatment, after applying methods like chemical coagulation, separation with membranes, or anaerobic reaction to significantly reduce COD. And given that previously treated vinasse presents low electric conductivity due to the reduction of the ion content, this situation is not recommendable because the consumption of electricity increases during the electrochemical treatment.

As primary treatment, some electrochemical techniques have been used through strict pH control, almost always maintaining it between 2 and 5, through adding acid media that ensure precipitation of weak acid species or weak alkaline with iron (III) to be able to feed sludge with reducing electrolytes. This situation determines the amount of material used in the electrodes from the electrolytic cells and limits its application to a certain class of effluents, as divulged in publication U.S. Pat. No. 5,538,636.

Other requirements for the electrochemical treatment are derived from using semi-impermeable membranes capable of separating the anodic zones from the cathodic zones to facilitate the separation process through ion exchange, membranes that also present coating films with sulfonic acid radicals substituted by perfluorinated groups that increase operating costs. In other cases, the cells are manufactured from materials like steel, carbon, and graphite or from platinized titanium or titanium coated with an oxide material, while for the present invention the cell electrodes are manufactured from iron.

In other cases, pretreatments are required—as in publications EP0861810 and U.S. Pat. No. 5,531,865, which require the application of ozone to make sure the wastes are free of thiosulfate forms, as well as oxidation with vapor or irradiation, associated to an oxidizing agent like hydrogen peroxide to the contaminated liquid medium within the electrolytic cell. This situation increases operating costs, inasmuch as the electrolytic cell used in these processes is steel in the cathode and diamond-coated silicon disks in the anode, which limits the destination of the process, given that for the publications it is only possible to treat waste liquids from photo developing processes or from wastewaters, while in the present invention, the procedure permits treating complex effluents from ethanol distilleries and from treatment plants of urban solid wastes.

In Valle del Cauca (Colombia), different strategies have studied for specific treatment of vinasse according to the destination assigned to the organic material, for example, at agricultural level raw vinasse is subjected to composting for its application as a fertilizer or as raw material to manufacture cellular protein and animal feed. However, these applications have disadvantages due to elevated periods of time they have to remain in storage, high cost of the investments, and operation difficulties in the processes.

### BRIEF DESCRIPTION OF THE INVENTION

Bearing in mind the limitations of the processes revealed in the state of the technique, a process has been developed that effectively combines techniques of: electrodissolution, flocculation, and oxidation to remove up to 98% of the total solids present in the effluent, which among the preferred modalities can be: leachate generated by sanitary landfills or municipal dumps, effluents from industrial wastewaters from ethanol production factories or yeast production factories. This process is carried out without having to recur to pretreatments.

Thus, the process from the present invention is a versatile alternative to treat wastewaters from industrial wastes; these could be from leachate generated by sanitary landfills and municipal dumps or from waters from distilleries with its application not merely limited the effluents mentioned.

The physical-chemical process proposed presents low consumption of electricity (less than 1.5 kWh/m³), easy automation and control, can be carried out at ambient temperature and pressure, does not use microorganisms, does not use costly chemical inputs that, in general, make it an alternative with low operating cost. Likewise, treated water can be reused in production processes and the sludge generated can become co-products with added value.

The present invention provides a process to reduce contents of COD, TOC, and total solids from industrial wastes or wastewaters, without recurring to preliminary treatments. The treatment comprises a sequence of stages of electrodissolution, flocculation, and oxidation. For electrodissolution an electrolytic cell is used provided with carbon steel, iron, or aluminum electrodes (current density of 0.3 to 2.0 mA/cm²). Depending on the type of wastewater different mixtures of co-adjuvants are used in the flocculation; among the preferred modalities some mixtures are used prepared with: lime (Ca(OH)₂), calcium chloride (CaCl₂), magnesium sulphate (MgSO₄), soda (NaOH), potassium hydroxide (KOH), phosphoric acid (H₃PO₄), and polyacrylamide (PAM). Finally, during the oxidation stage hydrogen peroxide is added to the supernatant from the flocculation promoting the Fenton reaction as one of the preferred modalities.

Among the most representative advantages of the electrodissolution, flocculation, and oxidation process there are: environmental compatibility, versatility, safety, ease of automation, low costs, and recovery of the organic material and minerals, given that instead of recurring to a great amount of chemical inputs or biological material (microorganisms), the method is aimed at the application of electricity (electrons) on electrolytic cells with metallic electrodes and addition of chemical inputs to remove COD, TOC, and total solids from wastewaters.

Additionally, this process requires low electrical consumption without producing significant degradation of the organic matter that is mostly separated during the flocculation stage.

The process is made up of the following stages: in the first, electrodissolution stage, iron or aluminum ions are added to the effluent through electrolytic dissolution of sacrificial anodes. In the second, flocculation stage, solids present in vinasse are removed via co-precipitation of metallic complexes like: iron or aluminum oxyhydroxides, iron or aluminum hydroxides, hydroxysulphates, phosphate, and calcium carbonate that act as adsorbents. During the third phase, oxidation stage, waste organic matter is degraded through Fenton-type reactions, as the preferred modality, and iron (III) or aluminum hydroxide insoluble complexes are also precipitated. The supernatant produced is retaken to the second phase (flocculation) to increase efficiency in the process.

Due to the process developed in the present invention, better results are obtained in percentage terms of the reduction of the total solids content (% RTS) and performance, through: adding H₂O₂ during oxidation, using steel or iron electrodes, low current density (0.3-2.0 mA/cm²), obtaining COD reduction above 90% and TOC reduction above 85%.

The advantages of the process lay in great part in that iron, applied as electrode material in electrodissolution processes to treat both leachate and vinasse, permits achieving a high level of reduction of COD and TOC content and turbidity (suspended solids). Additionally, the material used to manufacture the electrodes is economic and easily obtained compared to electrodes manufactured from more complex alloys.

Also, low current densities are required, which favors low consumption of energy in the process and lower requirements of initial pH in the solution, as well as in the hydrogen peroxide concentration, which directly impact upon the reduction of operating costs and on the efficiency of the process, through which we obtain a greater rate of TOC content reduction and a lower COD demand.

### BRIEF DESCRIPTION OF FIGURES

FIG. 1 shows the residual turbidity with respect to electrical load and percentage of vinasse solids with iron electrodes.

FIG. 2 illustrates the residual turbidity with respect to electrical load and percentage of vinasse solids with aluminum electrodes.

FIG. 3 shows the reduction COD content in the leachate treatment obtained through the process of the present invention

FIG. 4 shows the flow diagram of the process

### DETAILED DESCRIPTION OF THE INVENTION

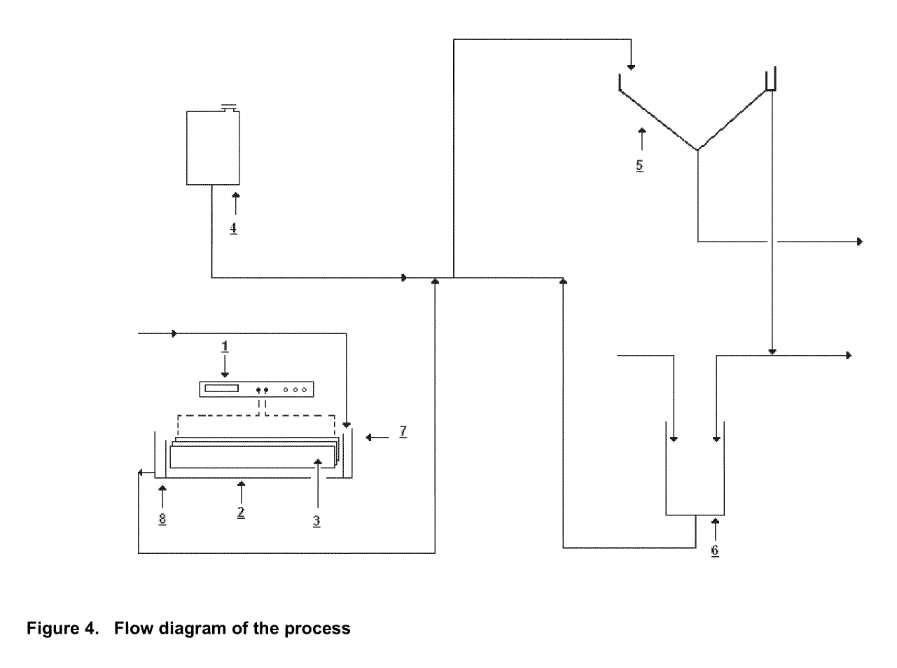

As noted in FIG. 4, the electrochemical cell (2) used in the process of the invention, (which in one of the preferred modalities corresponds to an electrolytic cell with monopole electrodes), is composed by a treatment chamber, an input for wastewater (7), an output for the pretreated water (8), an assembly of metallic elements that operate as electrodes (3), which in one of the preferred modalities can be elaborated in iron or aluminum, placed in said chamber to facilitate the flow of the bubbles formed by electrolysis, and a power source (1) connected to the assembly of assembly of metallic elements. Additionally, we have an oxidizing agent dosing container (4), a pH modifying agent dosing container (6), and a separation equipment (5).

Within the research process, different samples were analyzed for leachate from sanitary landfills and—particularly—from urban dumps the average values analyzed for a 4-month period regarding the biological oxygen demand and the chemical oxygen demand are the following: BOD₅ 27.817 mgO₂/l and COD 42.682 mgO₂/l. The amount of suspended solids was 2.512 mg/l, the amount of total solids corresponded to a value of 32.231 mg/l, the amount of fats and/or oils was 102.4 mg/l, the amount of sedimentable solids (10′) was 0.375 ml/l and sedimentable solids (60′) was 1.85 ml/l, conductivity 27.615 umhos/cm, total alkalinity 6.493 mg CaCO₃/l and acidity 1.277 mg CaCO₃/l.

The values detailed for the system used in the leachate treatment can change over time in response to the composition of wastes received by landfills or municipal dumps and from the amount of liquid wastes filtered by the system.

Also, and as far as the food industry (yeast production, for example), COD can vary in consideration to the characteristics of wastes liberated, but—in general—can range between 20.000 and 30.000 mg/l.

Vinasse from ethanol distilleries present elevated organic load, mineral salts, high values of chemical and biological oxygen demand (COD and BOD), turbidity and color.

Through the novel and inventive process herein claimed, no prior treatment is required to obtain COD, TOC, and total solid reduction from effluents The process to reduce COD, TOC, and total solids as per the invention comprises the following stages:
a) Feed an electrolytic cell provided with metallic electrodes (whose preferred modality corresponds to iron, steel, carbon, or aluminum electrodes) with wastewater; one of whose preferred modalities corresponds to vinasse from ethanol distilleries.
a)-1 In one of the preferred modalities an electrolytic cell is used, which uses a medium or mechanism that generates erosion on the electrodes maintaining the surface clean and notoriously improving metal electrodissolution.
b) Apply an electric current through said electrodes. In a preferred modality a direct current is used with a density between 0.3 and 2.0 mA/cm². Another modality prefers using current with alternating flow (change of polarity) to prevent soiling the electrodes.
c) Flocculate the colloids present in said contaminated liquid medium by adding co-adjuvants, whose preferred modalities are conducted with: calcium chloride (CaCl₂), soda (NaOH), lime (Ca(OH)₂), phosphoric acid (H₃PO₄), and polyacrylamide to generate co-precipitation (simultaneous precipitation) of metallic complexes, carbonates, and insoluble phosphates.
d) Remove sludge and the supernatant (or filtrate) obtained. In one of the preferred modalities, particularly for sludge from the vinasse, a co-product was obtained rich in organic matter and nutrients like potassium and phosphate that have big potential for use as organic fertilizer or as solid fuel.
e) Oxidize the organic and inorganic residual matter in the supernatant or filtrate through oxidizing agents. As preferred modality, we find hydrogen peroxide, through Fenton reactions (catalytic reaction between iron and hydrogen peroxide). Additionally, other oxidants may be used like ozone, permanganate, or related processes like electrochemical oxidation with boron-doped diamond electrodes.
f) The supernatant produced in e) is reused in step c) to increase the efficiency in the process.

The following examples present experimental trials of some of the preferred modalities that show the advantages of the procedure of the invention in comparison with results from the conventional techniques that use electrolytic cells with iron or aluminum electrodes and low current densities (less than 2 mA/cm² against more than 20 mA/cm²) to reduce the load of contaminants in industrial wastewaters, without thereby considering them limiting of the content and reach of the invention, as well as its application.

### Example 1

### Trials on Vinasse from Distilleries

Electrodissolution trials were carried out in a discontinuous electrolytic reactor with upstream flow and with permanent recirculation. A monopolar arrangement was available in the electrodes and five stainless steel cathodes were used and six steel to carbon anodes. A 3-mm distance was set between electrodes and a total anodic area of 900 cm² was established.

For the flocculation trials, 100-ml volumes of vinasse previously treated with electrodissolution were taken and diluted at different concentrations of solids: 1%, 2%, 3%, and 4% (p/p). Each sample was brought to pH 11.5 by adding Ca(OH)₂ and was subjected to rapid agitation (700 rpm) for one minute; thereafter, it was subjected to slow agitation (60 rpm) for 10 minutes.

The samples were left to decant for 10 minutes and turbidity measurements were taken of the supernatant liquid. This liquid was separated and hydrogen peroxide was added to it.

The influence of the electrical load (Coulombs) and of the concentration of solids (p/p) on residual turbidity was evaluated. During the trials, monitoring was performed of the pH behavior and of the electrical conductivity of the suspension.

During electrocoagulation, three levels of electrical load were supplied: 5,000; 7,500, and 10,000 Coulombs, with a replicate for each trial.

### Results and Analysis

To reduce turbidity (RT) and diminish turbidity (DT) the following formulas were used:

$$\% RT = ( \frac{initial\_turbidity - final\_turbidity}{final\_turbidity} ) * 100$$

$$\% DT = ( \frac{final\_Turbidity}{initial\_Turbidity} ) * 100$$

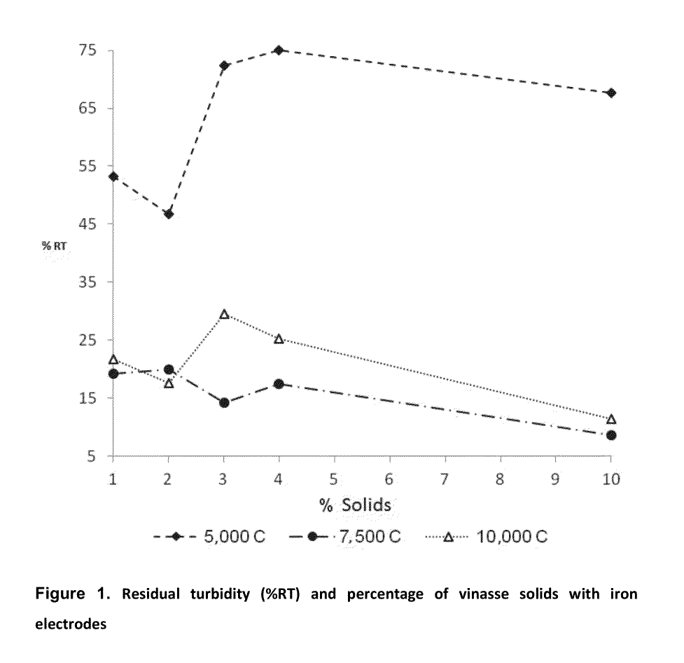

Upon providing 5,000 Coulombs (FIG. 1) the maximum 70% removal was reached for vinasse concentrated at 2% (p/p) and diminished to 30% for vinasse concentrated at 4% (p/p) using iron electrodes. For this case, turbidity diminished with increased concentration of solids in the vinasse—as evidenced in FIG. 1, which shows turbidity reduction versus concentration of solids in the vinasse.

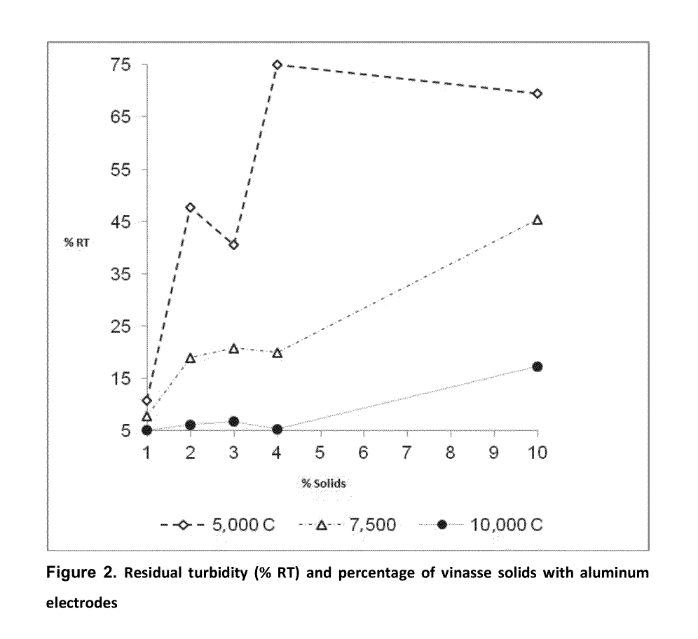

Likewise, removal was accomplished above 90% RT as the supply of electrical load increased reaching a maximum of 93% RT with 7,500 Coulombs and vinasse concentrated at 3% (p/p). FIG. 2 shows the final turbidity tendencies (DT) with respect to the concentration of solids in the treated vinasse when aluminum anodes were used.

### Final Trials

The following parameters were fixed for iron and aluminum anodes:

Initial natural pH of the vinasse (pH=4.6)
J=0.33 mA/cm²

The lower percentage values of residual turbidity correspond to values of 5,000 Coulombs for iron electrodes, which corresponds to low energy consumption (1.1 kWh/m³); although the lowest tendency was obtained with 7,500 Coulombs (FIG. 1).

### Example 2

### Trials on Leachate from Sanitary Landfill

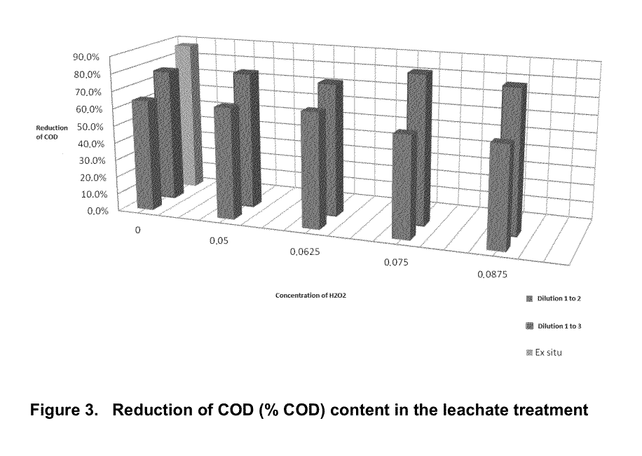

The leachate treatment was carried out from a sanitary landfill; results at different operating conditions are shown in FIG. 3. The same equipment as for example 1 was used.

The conditions for the electrochemical reactor were: operating pH between 4 and 5 and load in the reactor between 5,000-10,000 Coulombs per liter through direct current and iron electrodes.

The flocculation stage required a pH up to 11.5 using slaked lime, and for the oxidation process the amount of peroxide used ranged between 200 and 5,000 ppm.

### Results

The leachate presented initial turbidity of 645 NTU (Nephelometric turbidity units) and after using the same process as in example 1, a liquid was obtained with a final turbidity of 7.25, that is, 98.9% reduction of solids content was produced.

NTU Original turbidity=645
NTU final turbidity=7.25
Percentage of turbidity reduction=98.9%

### Example 3

### Trials on Biologically Pretreated Vinasse

Treatment was conducted on pretreated vinasse from the yeast farming industry. The effluent from an activated sludge anaerobic reactor (UASB) presented the following initial characteristics:

Sample A. COD (ppm)=7,758

After the treatment, the sample presented the following characteristic:

Sample A. COD (ppm)=558

The percentage of reduction of COD content after treatment was 93%. The same procedure from example 1 was used.

### Example 4

### Trials on Effluents from a Food Industry

Treatment was conducted on vinasse, without prior treatment, from the yeast farming industry. The effluent presented the following initial characteristics:

Sample A. pH=5.78, Conductivity (mS/cm)=4.49, COD (ppm)=26,730
Sample B. pH=3.11, Conductivity (mS/cm)=1.37, COD (ppm)=28,274

After the treatment, the samples presented the following characteristics:

Sample A. pH=11.03, Conductivity (mS/cm)=3.27, COD (ppm)=3,231
Sample B. pH=10.83, Conductivity (mS/cm)=2.36, COD (ppm)=4,779

The percentage of reduction of COD content was 88% for sample A and 83% for sample B.

### Example 5

### Trials on Water from Petroleum Wells

Treatment was conducted on waters from petroleum wells to eliminate chloride ions and metallic ions; the same process described in example 1 was used. Removal was obtained at 15% in chlorides, 100% in strontium (Sr), between 26 and 49% in Barium (Ba), 95% in Magnesium, 100% silica (SiO₂), and 94% in iron (Fe). The following table presents the results under different conditions.

| INITIAL SAMPLE | | | TREATED SAMPLE | | | |
|---|---|---|---|---|---|---|
| | | Initial | | Oxidant | Concen- | Percentage |
| | | concen- | | concen- | tration | of reduction |
| | | tration of | | tration | of Cl⁻ | of Cl— |
| Sample | | Cl—(mg/l) | pH | (ppm) | (mg/l) | content |
| 1 | 1.1 | 425 | 8.73 | 3 | 210 | 50.6% |
| | 1.2 | 425 | 9.17 | 1.5 | 410 | 3.5% |
| | 1.3 | 425 | 11.38 | 3 | 382 | 10.1% |
| | 1.1Replicate | 425 | 9.33 | 3 | 240 | 43.5% |
| | 1.5 | 425 | 9.17 | 4.5 | 280 | 34.1% |
| 2 | 2.1 | 405 | 8.95 | 3 | 360 | 11.1% |
| | 2.3 | 405 | 8.79 | 1.5 | 390 | 3.7% |
| 3 | 3.2 | 510 | 8.89 | 3 | 350 | 31.4% |
| | 3.3 | 510 | 9.72 | 1.5 | 330 | 35.3% |
| 4 | 4.2 | 415 | 11.28 | 1.5 | 380 | 8.4% |
| | 4.3 | 415 | 9.15 | 3 | 370 | 10.8% |

Although the present invention has been described with the preferred embodiments shown, it remains understood that the modifications and variations that conserve the spirit of the reach of this invention are understood within the reach of the claims attached.

1. A process to reduce COD, TOC, and total solids from a contaminated liquid medium, which comprises the following stages:
a) Feed an electrolytic cell provided with electrodes with the contaminated liquid medium;
b) Apply a constant direct current through said electrodes;
c) Flocculate the solids present in said contaminated liquid medium by adding coadjuvant agents.
d) Remove the sludge supernatant obtained;
e) Oxidize the supernatant through oxidizing agents.

2. The process to reduce COD, TOC, and total solids pursuant to claim 1, where, additionally, the supernatant produced in step e) is reused as of step c).

3. The process to reduce COD, TOC, and total solids pursuant to claim 1, characterized because the electrodes from step a) are manufactured from a material selected from the group that comprises iron, steel to carbon, aluminum, and a combination of them.

4. The process to reduce COD, TOC, and total solids pursuant to claim 1, where the operation pH in the electrochemical reactor is between 4 and 5.

5. The process to reduce COD, TOC, and total solids pursuant to claim 1, where the load in the electrochemical reactor is between 5,000 and 10,000 Coulombs per liter, and it is applied through direct current.

6. The process to reduce COD, TOC, and total solids pursuant to claim 1, where the density of the direct current is between 0.3 and 2.0 mA/cm².

7. The process to reduce COD, TOC, and total solids pursuant to claim 1, where the oxidizing agent from stage e) is hydrogen peroxide.

8. The process to reduce COD, TOC, and total solids pursuant to claim 7, characterized because in stage (e), the concentration of hydrogen peroxide injected to said contaminated liquid medium is between 20 to 5,000 ppm.

9. The process to reduce COD, TOC, and total solids pursuant to claim 1, characterized because the organic part of the sludge obtained in step c) can be employed to manufacture fuels.

10. The process to reduce COD, TOC, and total solids pursuant to claim 1, characterized because the inorganic and organic parts of the sludge obtained in step c) are matter used in the manufacture of agro-fertilizers.
